(19) United States
(12) Patent Application Publication
(10) Pub. No.: US 2007/0025572 A1
(43) Pub. Date: Feb. 1, 2007

(54) Loudspeaker

(76) Inventor: James W. Forte, Farmingdale, NY (US)

Correspondence Address: COOPER & DUNHAM, LLP, 1185 AVENUE OF THE AMERICAS, NEW YORK, NY, 10036, US

(21) Appl. No.: 11/195,405

(22) Filed: Aug. 1, 2005

(51) Int. Cl. H04R 25/00

(52) U.S. Cl. 381/182

(57) ABSTRACT

The pole piece of a loudspeaker woofer is formed with a recess in which a tweeter is mounted so that the woofer and the tweeter face in the same direction and produce a merged step response.

### BACKGROUND OF THE INVENTION

1. Field of the Invention

This invention relates to loudspeakers and in particular to a novel and highly effective upscale loudspeaker that produces an unusually large optimal listening area and is designed to appeal to the most demanding aficionados of high-fidelity sound reproducing systems but can be produced at a reasonable cost.

2. Description of the Prior Art

High-end systems for reproducing sound, especially music, must be essentially free of distortion over a frequency range of about ten octaves—say from a frequency of about 20 Hz to one of about 20 kHz. No loudspeaker developed to date can meet that need, so two or more loudspeakers are typically used together, for example a woofer for reproducing low- and mid-frequency sound and a tweeter for reproducing mid- and high-frequency sound. Both the woofer and the tweeter contribute to the sound as reproduced in a midrange. In that range the response of the woofer falls off and that of the tweeter correspondingly increases with increasing frequency.

The use of multiple speakers operative in different parts of the audible spectrum addresses the problem that no single speaker developed to date responds adequately over the entire frequency range of human hearing. But it introduces another problem: in all conventional placements of the two speakers, their respective step responses are mismatched.

The step response of a speaker is determined by placing a microphone at a chosen location in front of a speaker, supplying a square wave DC voltage to the speaker voice coil, and determining the response of the speaker by measuring that of the microphone. The response of the microphone includes a time delay that depends on the speed of sound and the distance between the speaker and the microphone. A fuller explanation of step response appears in “Testing Loudspeakers,” by Joseph D'Appolito, Audio Amateur Press, First Edition, ISBN 1-882580-17-6, in which the ideal step response of a loudspeaker is illustrated on page 124.

Perhaps the most common practice, and one that is many decades old, is to center the woofer and speaker on respective axes that are offset from each other. That means that a single instrument capable of producing both low and high notes, such as a piano or violin, seems to a listener to be at different locations, depending on the note or notes being reproduced at a given moment. The instrument can actually seem to be in two places at once if both low and high notes are produced at the same time, as is often the case. It is even possible that a single fundamental tone and its own overtones (harmonics) will appear to emanate from different locations.

Moreover, if the offset axes are parallel to each other, there is no point in the listening area that is on-axis with respect to both speakers. So a listener who is on-axis with respect to one speaker is necessarily off-axis with respect to the other speaker. In general, a listener's displacement from the two axes will be different, and the sounds emanating from the woofer and tweeter will be experienced differently. If the speakers are angled towards each other, the axes may intersect, but only at one point. At all other points in the listening area, a listener who is on-axis with respect to one speaker is necessarily off-axis with respect to the other speaker. As in the case where the axes are parallel, a listener's displacement from the two axes will in general be different, and the sounds emanating from the woofer and tweeter will be experienced differently. These limitations of the prior art restrict the physical size of the listening area, so that often only one listener at a time can be optimally positioned.

A more recent practice is to mount the woofer and tweeter on the same axis, the tweeter being nested in the woofer. This establishes a line of listening positions that are on-axis with respect to both speakers, and a listening position that is off-axis with respect to one speaker is off-axis to the same extent with respect to the other speaker.

But that improvement is not a complete solution to the problem of seamlessly integrating the outputs of two speakers. The acoustic center of a tweeter conventionally nested in a woofer is physically closer to a listener than is that of the woofer. Moreover, by virtue of its low mass, a tweeter responds to activation by a voice coil more rapidly than a woofer does. These two effects work additively to cause the step response of the tweeter to be phase-advanced relative to that of the woofer.

Delaying the phase of the signal supplied to the tweeter voice coil relative to that of the signal supplied to the woofer voice coil might be considered as a solution to the problem of phase mismatch. But phase-delay circuitry is a source of signal distortion and is unacceptable in high-end audio equipment.

Finally, the use of neodymium loudspeaker magnets has become popular because they make it possible to reduce the size of the speakers and therefore to place them closer together. But neodymium magnets are expensive compared to ferrite magnets and, while they enable a reduction of the geometric distortion and phase mismatch, they do not, in conventional practice, enable their elimination.

### OBJECTS AND SUMMARY OF THE INVENTION

An object of the invention is to remedy the problems of the prior art discussed above and in particular to provide a way of seamlessly integrating the outputs of two or more speakers. From another standpoint, an object of the invention is to provide for the reproduction of sound from a woofer and a tweeter in such a manner that their respective sound waves have substantially the same directionality and timing as perceived from any location in the listening area, thereby making all such locations essentially optimal.

The foregoing and other objects of the invention are attained in a preferred embodiment thereof by providing a loudspeaker comprising a woofer having a pole piece formed about an axis, the pole piece having a coaxial recess. A tweeter is mounted in the recess so that the woofer and the tweeter face in the same direction and produce a merged step response.

### BRIEF DESCRIPTON OF THE DRAWING

A better understanding of the objects, features and advantages of the invention can be gained from a consideration of the following detailed description of the preferred embodiments thereof, in conjunction with the appended figures of the drawing, wherein:

FIG. 1 is a schematic view in axial section of a woofer and a tweeter, the tweeter being conventionally nested coaxially within the woofer;

FIG. 1A is a view similar to FIG. 1 and showing the displacement of the acoustic center of the tweeter from that of the woofer;

FIG. 1B is a view taken along the line 1B-1B of FIG. 1 and looking in the direction of the arrows;

FIG. 2 is a view similar to FIG. 1 but showing the invention;

FIG. 2A is a view similar to FIG. 2 and schematically showing the relative positions of the acoustic centers of the woofer and the tweeter in accordance with the invention;

FIG. 2B is a view taken along the line 2B-2B of FIG. 1 and looking in the direction of the arrows;

FIG. 3 is an illustration of the step response of a woofer positioned in a selected location as in FIG. 1 or 2;

FIG. 4 is an illustration of the step response of a tweeter conventionally positioned relative to the woofer, as in FIG. 1;

FIG. 5 is an illustration of the combined step response of a woofer and tweeter positioned as in FIG. 1, in accordance with the prior art;

FIG. 6 is an illustration of the step response of a tweeter positioned as in FIG. 2, in accordance with the invention; and

FIG. 7 is an illustration of the combined step response of a woofer and tweeter positioned as in FIG. 2, in accordance with the invention.

### DESCRIPTION OF THE PREFERRED EMBODIMENTS OF THE INVENTION

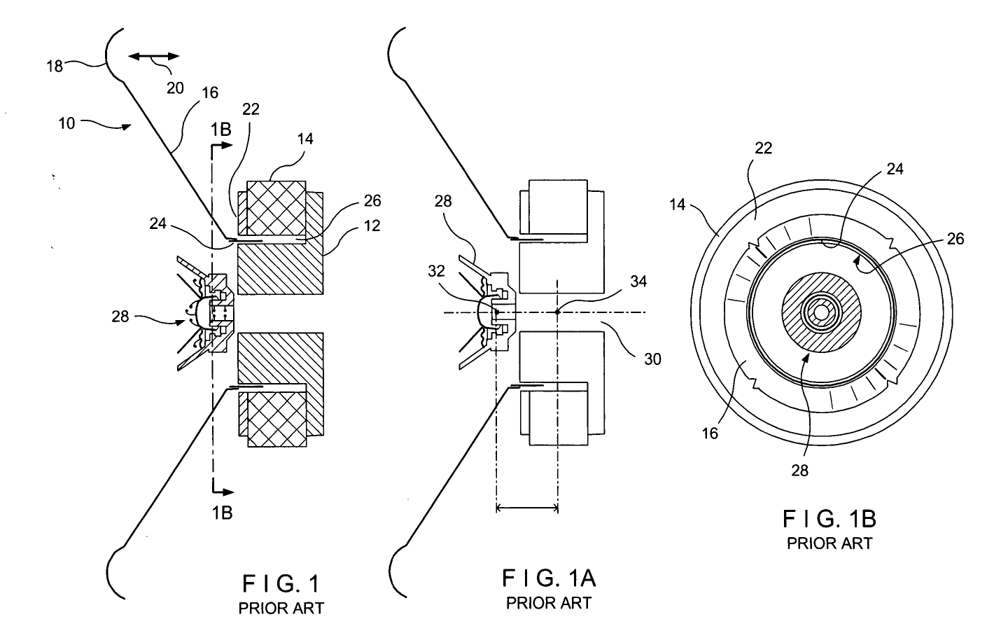

FIGS. 1 and 3-5 illustrate a problem of the prior art that the present invention overcomes. FIG. 1 shows a woofer 10 comprising a pole piece 12, a magnet 14, and a cone 16. A surround 18 on the outer periphery of the cone 16 anchors the cone to a support (not shown). The connection of the cone 16 to the support is flexible so that the cone can move left and right, in the directions of the arrow 20 in FIG. 1. A top plate 22 secures the magnet 14 in position. The cone 16 is open at the center and attached on its inner periphery to a voice coil 24 that lies at least partly in an annular gap 26 between the pole piece 12 and the magnet 14.

An electrical drive signal representing the sound to be reproduced by the woofer 10 is supplied by leads (not shown) to the voice coil 24. The interaction between the dynamic magnetic field due to the drive signal flowing through the voice coil 24 and the static magnetic field produced by the magnet 14 causes the voice coil 24 and therefore the cone 16 to move in a way that generates a sound that corresponds to the signal and to the originally recorded sound that the signal represents.

A tweeter 28 can be nested coaxially within the woofer of FIG. 1, as that figure shows, but a tweeter of a size compatible with that of the woofer 10 will not fit in the center hole 30 and must therefore be mounted to the left of the woofer pole piece 12. This places the acoustic center 32 of the tweeter to the left of the acoustic center 34 of the woofer, and therefore closer to a listener than is the acoustic center of the woofer. That plus the faster response of the tweeter to application of a signal gives rise to separated step responses, which listeners perceive as a phase mismatch.

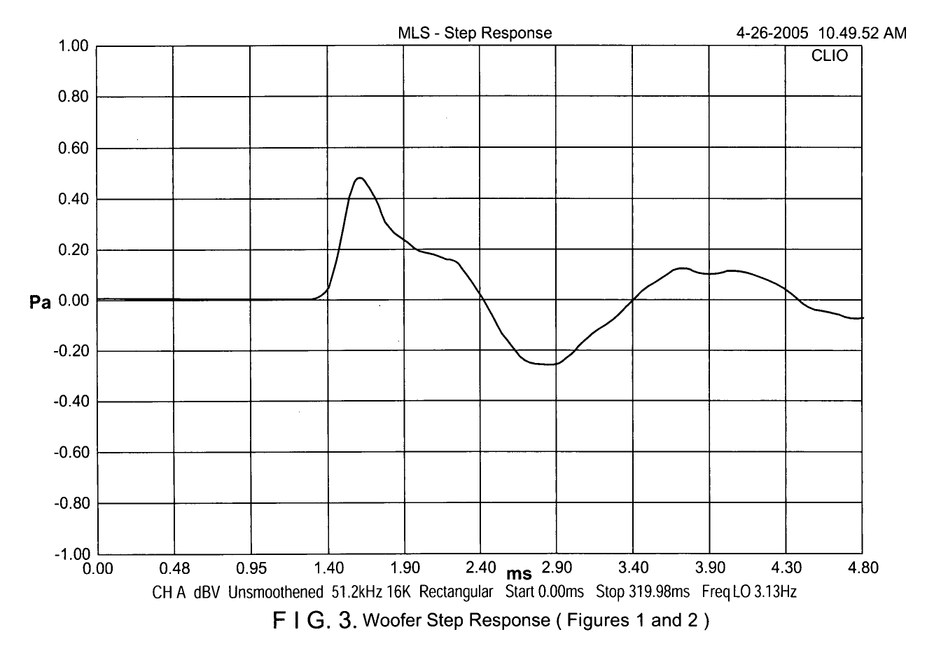

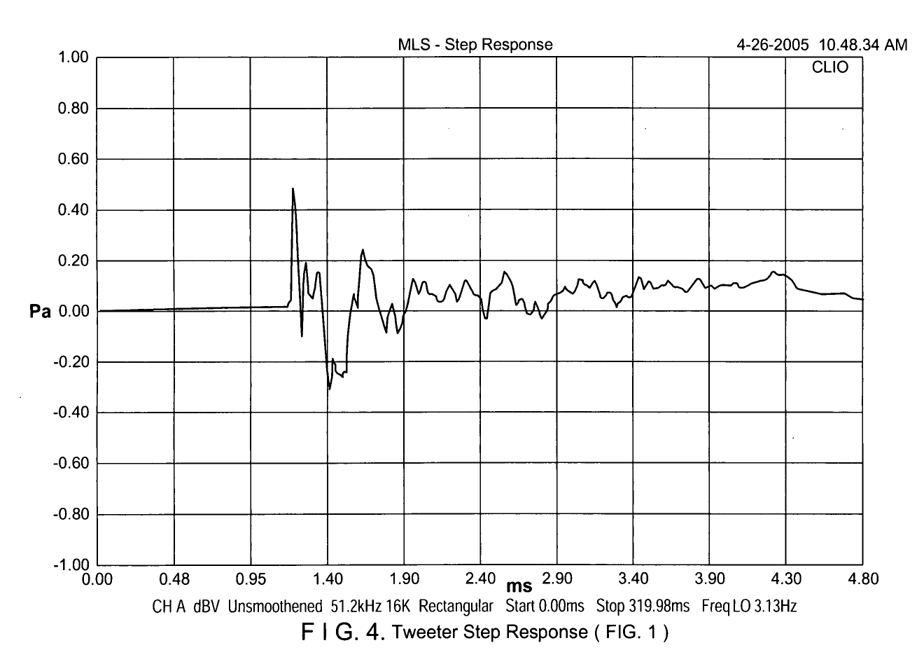

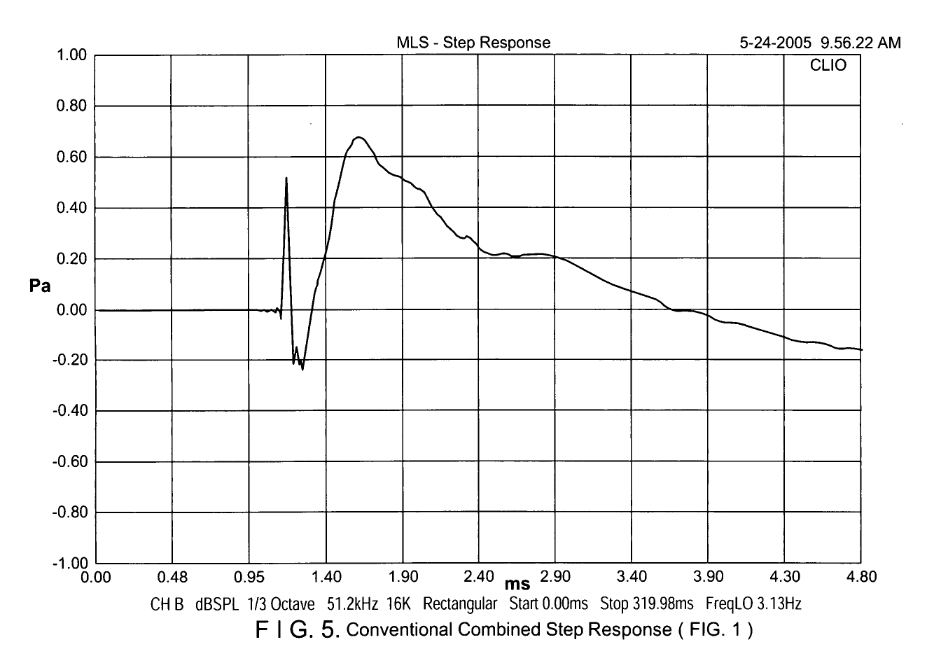

FIGS. 3-7 are drawn to the same scale. FIGS. 3-5 illustrate the problem of the prior art that the present invention addresses. The woofer step response shown in FIG. 3 is time-delayed with respect to the tweeter step response shown in FIG. 4, so that they display separated peaks when shown on the same graph, as in FIG. 5, which shows a tweeter response that peaks before, and a woofer response that peaks after, 1.4 milliseconds.

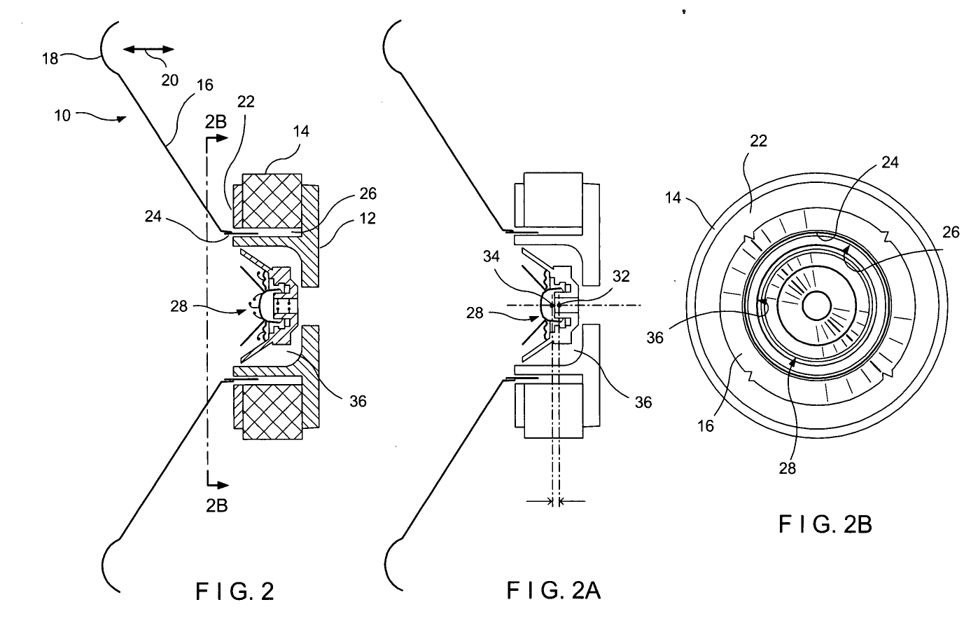

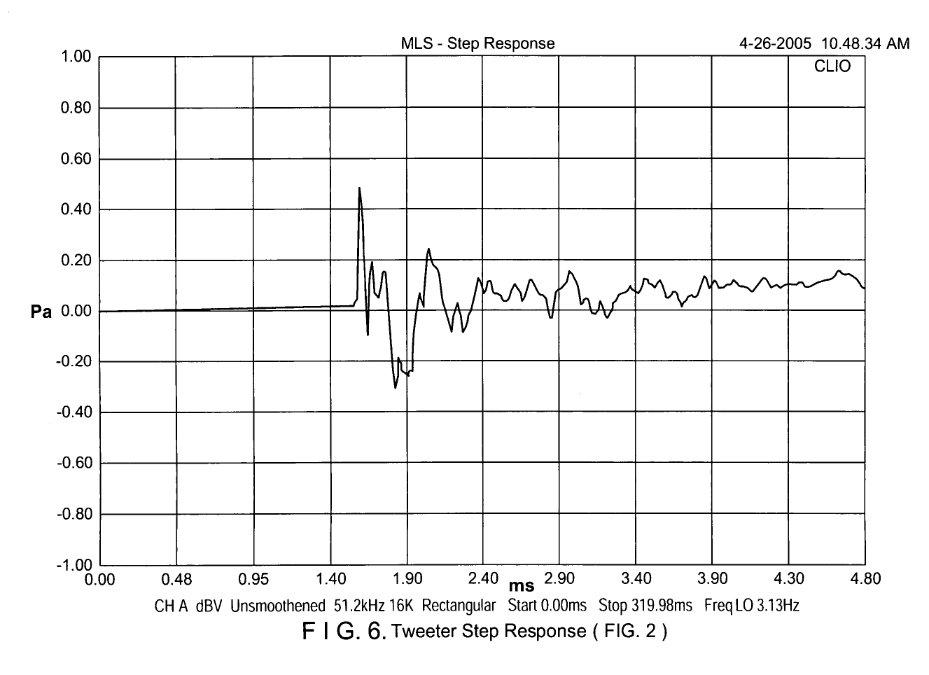

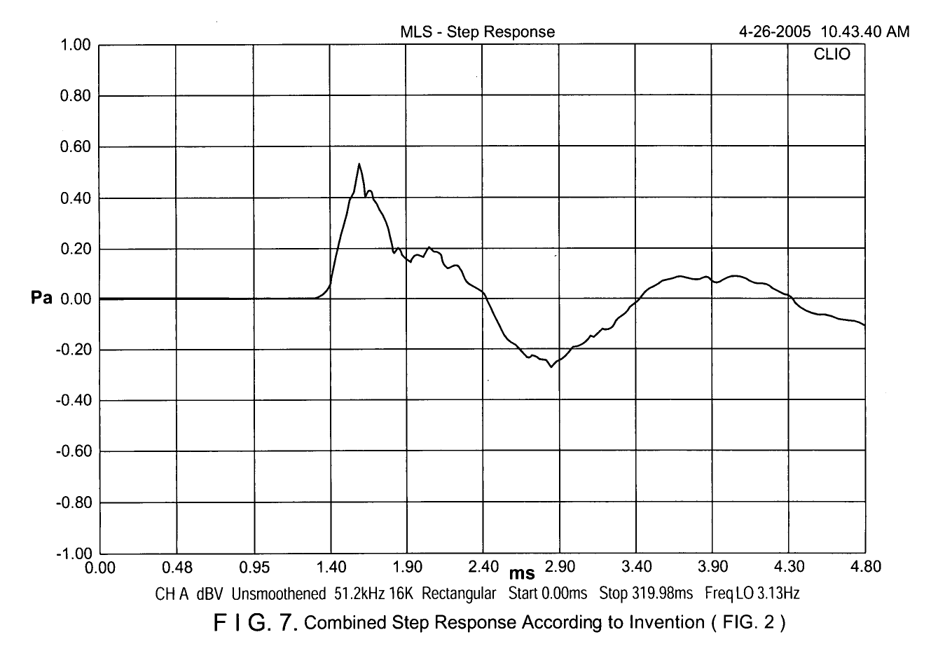

FIG. 2 shows the invention, which comprises a coaxial recess 36 formed in the pole piece 12. The tweeter 28 is mounted in the recess 36 so that, from the perspective of FIG. 2, the acoustic center 32 of the tweeter is not quite congruent with the acoustic center 34 of the woofer but is preferably somewhat to the right thereof, in order to compensate for the faster response time of the tweeter. The step response of the tweeter positioned as in FIG. 2 is delayed relative to the step response of the tweeter positioned as in FIG. 1, as a comparison of FIGS. 6 and 4 clearly shows. When the woofer and tweeter are both in operation, as is the normal case, their step responses are merged when they are mounted as in FIG. 2, as FIG. 7 clearly shows. This means that the step response of the tweeter rides on that of the woofer, so that the overall step response (FIG. 7) looks very much like that of the woofer by itself (FIG. 3).

In accordance with the invention the magnet 14 is preferably made of ferrite material, which, though inexpensive, is excellent in terms of its performance. But it is within the scope of the invention to use other materials for the magnet, including a rare-earth material such as neodymium. A ferrite magnet can also be used in the tweeter. The pole piece 12 is preferably made of steel, but it can be made of cobalt or another material, as those skilled in the art will understand.

The discussion above is in terms of monaural or single-track sound reproduction, but of course the invention is also applicable to stereo sound reproduction. In the case of multiple tracks, the tweeter for each track is nested in the woofer for the same track to produce a merged step response for that track.

The conventional view of those skilled in the art has been that the pole piece must have essentially the geometry shown in FIG. 1 in order to achieve adequate system performance. Experimental tests run on a system including a pole piece as shown in FIG. 2 have surprisingly shown that system performance is not degraded by the excision of enough material from the pole piece to serve the purposes of the invention. The invention therefore improves the system performance as indicated above without any offsets.

Thus there is provided in accordance with the invention a novel and highly effective loudspeaker that produces an unusually large optimal listening area in which the sounds emanating from the woofer and the tweeter are seamlessly integrated. Apparatus in accordance with the invention can be constructed as inexpensively as conventional apparatus, or, by virtue of the material savings in the pole piece, even less expensively.

Moreover, other factors being the same, the weight of a loudspeaker constructed in accordance with the invention is less than that of a conventional loudspeaker because of the excision of material from the pole piece to form the recess. This makes the invention advantageous not only in environments in which high-fidelity reproduction of sound is important, for example homes, businesses, and schools, but also in those in which weight savings are important, for example space vehicles, airplanes and motor vehicles.

The preferred embodiment of the invention disclosed herein can be modified without departing from the principles of the invention, as those skilled in the art will understand. In particular, one can vary the absolute and relative sizes of the woofer and the tweeter, the materials of which they are made, the size and shape of the recess 36 (it can, for example, be contoured to be a close fit with the tweeter), and the position of the tweeter within the recess (and therefore the relative positions of the acoustic centers 32 and 34). The invention includes all structures and methods that fall within the scope of the appended claims.

I claim:

1. A loudspeaker comprising:
a woofer having a pole piece formed about an axis, the pole piece having a coaxial recess; and
a tweeter;
the tweeter being mounted in the recess so that the woofer and the tweeter face in the same direction and produce a merged step response.

2. A loudspeaker according to claim 1 wherein the pole piece is formed at least in part of steel.

3. A loudspeaker according to claim 1 wherein the woofer comprises a speaker cone and a magnet and a voice coil for activating the cone, and the magnet is formed at least in part of ferrite material.

4. A loudspeaker according to claim 1 wherein the woofer comprises a speaker cone and a magnet and a voice coil for activating the cone, and the magnet is formed at least in part of a rare-earth material.

5. A loudspeaker according to claim 1 wherein the tweeter comprises a speaker cone and a magnet and a voice coil for activating the cone, and the magnet is formed at least in part of ferrite material.

6. A loudspeaker according to claim 1 wherein the tweeter comprises a speaker cone and a magnet and a voice coil for activating the cone, and the magnet is formed at least in part of a rare-earth material.

7. A loudspeaker according to claim 4 wherein the rare-earth material comprises neodymium.

8. A loudspeaker according to claim 6 wherein the rare-earth material comprises neodymium.

9. A method of manufacturing a loudspeaker comprising:
providing a woofer having a pole piece formed about an axis, the pole piece having a coaxial recess;
providing a tweeter; and
mounting the tweeter in the recess so that the woofer and the tweeter face in the same direction and produce a merged step response.

10. A method according to claim 9 comprising starting with a pole piece of conventional shape and excising a portion of it to form the recess.

11. A method according to claim 9 comprising the further step of mounting the loudspeaker in an environment where weight savings are important.

12. A method according to claim 9 wherein the environment is selected from the group consisting of a home, a business, a school, a space vehicle, an airplane, and a motor vehicle.
